(19) United States
(12) Patent Application Publication
(10) Pub. No.: US 2026/0270645 A1
(43) Pub. Date: Sep. 10, 2026

(54) SYSTEM AND METHOD FOR CONDITIONALLY ADJUSTING LOCATION-BASED CONTENT

(71) Applicant: Andrew Doughty, Shalimar, FL (US)

(72) Inventor: Andrew Doughty, Shalimar, FL (US)

(21) Appl. No.: 19/075,101

(22) Filed: Mar. 10, 2025

(51) Int. Cl. H04W 4/021

(52) U.S. Cl. CPC H04W 4/021

(57) ABSTRACT

A method and system may allow an operator to select a location and create a conditional message for such location, including information on the conditions under which the message should be activated and deactivated. When the condition for activation is in effect, a user in the location is presented with the conditional message. A primary message may also be recorded for the location and presented to a user in the location when the condition for activation is not in effect. When the condition for activation is in effect, the conditional message may replace or supplement any primary message for that location. Conditional messages may be grouped to ease the effort to create, edit, activate, and/or deactivate the conditional message(s) for multiple locations.

### COPYRIGHT AND TRADEMARK STATEMENT

A portion of the present disclosure may contain material that is subject to copyright protection. The copyright owner(s) has no objection to the facsimile reproduction by anyone of the patent document or the patent disclosure as it appears in the Patent and Trademark Office patent file or records, but otherwise reserves all copyright rights whatsoever. Trademarks may be used in the present disclosure, and the applicant(s) make no claim to any trademarks referenced.

### FIELD OF THE INVENTION

The invention relates in general to the field of providing informational content to users based on their current location.

### BACKGROUND OF THE INVENTION

Applications exist for providing users with information content based on the current location of the user. A typical example is a GPS audio tour which operates in coordination with a mobile computing device such as a smart telephone, vehicle navigation system, or similar device. Such a tour application allows users to hear audio messages via the mobile device when they reach a specific location. Such messages can be extremely helpful to users because, as they drive or walk through a town, city, park, or other location, they can get helpful advice on what to see and do and be entertained by stories and legends about an area. These audio tours are mainly created by private companies and/or local government as the audio equivalent of a tour guide.

### SUMMARY OF THE INVENTION

Bearing in mind the problems and deficiencies of current location-based message capabilities, it is therefore an object of the present invention to provide a method and system that allow an operator to easily create conditional messages for presentation to users in a particular location under appropriate conditions.

According to one aspect of the present disclosure, a method for managing location-based content may comprise the steps of creating a record for at least one location (such record including a geographical identity of the location, an activation radius, and a conditional message for the location), defining at least one condition under which the conditional message is to be activated and at least one condition under which the conditional message is to be deactivated, determining whether the at least one condition under which the conditional message is to be activated is currently met and, responsive to such determination, activating the conditional message to be presented to users located within the activation radius, and determining whether the at least one condition under which the conditional message is to be deactivated is currently met and, responsive to such determination, deactivating the conditional message.

The step of creating a record may further comprise creating a primary message for each of at least a subset of locations, and creating a record of whether a particular conditional message for that location should replace the primary message. In such cases, the step of activating the conditional message may include checking the record for the conditional message to be activated to determine whether the conditional message should replace the primary message and, if so, replacing the primary message with the conditional message until such time as a determination is made to deactivate the conditional message, at which time the primary message replaces the conditional message, and alternatively, presenting users with both the conditional message and the primary message until such time as a determination is made to deactivate the conditional message, at which time the conditional message is deactivated and only the primary message is presented to users within the activation radius.

The step of creating a record may, for at least a subset of conditional messages, further comprise recording a category for each such conditional message, such categorized conditional message being common to at least a subset of locations. In such cases, the step of activating the conditional message may comprise activating the conditional message for users located within the activation radius of all locations to which the category of the activated message is common.

The conditions under which a conditional message is activated and deactivated may include at least one condition selected from the group of:
an activation time/date and a deactivation time/date;
the onset and cease of a defined weather condition;
the onset and cease of an activity that impacts road travel; and
the onset and cease of a community social activity.

The conditions under which a conditional message is activated and deactivated may include direct activation and deactivation by an operator.

The conditional messages may be audio messages that are created by at least one technique selected from the group of recording audio of an operator delivering the message and using a computer-generation capability to convert text entered by an operator into computer-generated audio.

The method may include the step of communicating the conditional message to at least one user device, in which case the steps of determining whether the conditional message is to be activated and activating the conditional message and determining whether the conditional message is to be deactivated and deactivating the conditional message may be performed partially or entirely by the user device.

A storage medium may comprise instructions that, when executed by a processing device, executes one or more of the methods as described above.

According to an aspect of the present disclosure, a system for managing location-based content may include a message database, at least one operator interface programmed to allow an operator to create a record in the message database for at least one location (such record for each location including geographical coordinates of the location, an activation radius, and a conditional message for the location), the operator interface also being programmed to allow an operator to define at least one condition under which the conditional message is to be activated and at least one condition under which the conditional message is to be deactivated, at least one communication channel for communicating conditional messages to at least user devices located within the activation radius of any location associated with that conditional message, a message manager programmed to determine whether the at least one condition under which the conditional message is to be activated is currently met and, responsive to such determination, presenting the conditional message via user devices located within the activation radius, and also programmed to determine whether the at least one condition under which the conditional message is to be deactivated is currently met and, responsive to such determination, deactivating the conditional message.

The operator interface may be programmed to allow an operator to create a primary message in the message database for each of at least a subset of locations, and to record in the message database whether a particular conditional message for that location should replace the primary message when activated. The message manager may programmed such that, upon determining that a conditional message is to be activated, it checks the record for the conditional message to determine whether the conditional message should replace the primary message and if so, the message manager replaces the primary message with the conditional message until such time as a determination is made to deactivate the conditional message (at which time the primary message replaces the conditional message), and alternatively presenting both the conditional message and the primary message via user devices within the activation radius until such time as a determination is made to deactivate the conditional message (at which time the conditional message is deactivated and only the primary message is presented via user devices).

The operator interface may be programmed to allow an operator to record in the message database, for at least a subset of conditional messages, a category for each such conditional message, such categorized conditional message being common to at least a subset of locations. In such cases, the message manager may be programmed such that, when it is determined that a categorized message is to be activated, the message manager presents such conditional message to user devices located within the activation radius of all locations to which the category of the activated conditional message is common.

The conditions under which a conditional message is activated and deactivated may include at least one condition selected from the group of:
an activation time/date and a deactivation time/date;
the onset and cease of a defined weather condition;
the onset and cease of an activity that impacts road travel; and
the onset and cease of a community social activity.

The message manager may be programmed to allow an operator to directly activate and deactivate a conditional message.

The message database may store the conditional messages as audio messages and the operator interface may be programmed to allow an operator to create such audio messages by at least one technique selected from the group of recording audio of an operator delivering the message and using a computer-generation capability to convert text entered by an operator into computer-generated audio.

The message database and the message manager may be provided, entirely or in part, by at least one application operating on a user device.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1A is a flow chart showing one example of an overall method for creating, storing, and publishing conditional message information for one or more locations.

FIG. 1B is a flow chart showing one example of some steps that could be employed in a method such as shown in FIG. 1A for selecting a location and creating a conditional message associated with that location.

FIG. 1C is a flow chart showing one example of a method for presenting a user with either a non-conditional or a conditional message when the user approaches a location.

FIG. 2 is a block diagram illustrating one example of a system for managing conditional messages to be provided to users based on the location of the user.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described. Where functionalities are described for either a system or method, it should be appreciated that such description of either an application or method applies to the other, and any details of such functionality should be considered applicable to either a method or application, or to a system that employs such application and/or performs such method.

While the discussion herein describes methods and systems with reference to audio messages, in some situations other formats of information messages, such as text messages and/or graphic or video messages, might be employed in place of or in addition to audio messages.

The present method and system allow an operator to easily modify location-based informational messages provided to a number of users when the users are in a location where a particular message is appropriate. The operator can adjust the message (typically either replacing or supplementing an existing message for that location) based on conditions such as during a particular range of date and/or time. As one example of such location-based messages, GPS audio tours allow users of a mobile app to hear an audio played over their smart phone, vehicle navigation system, or other mobile computing device when they reach a specific location. These messages can be extremely helpful to users because, as they drive or walk through a town, city, park, or other area, they can get helpful advice on what to see and do and be entertained by stories and legends about an area. These audio tours may be created by private companies or government agencies as the audio equivalent of a tour guide, and the audios rarely change. In some cases, “preview” messages may be presented to users who are not physically present at the location, but who select the location such as by clicking a map point for the location.

Populating the audios for multiple locations is typically a cumbersome and time-consuming process, not conducive to making numerous or rapid changes as conditions warrant, and requires human intervention whenever an audio needs to be replaced. It also may not be possible to rapidly replace or supplement pre-selected groups of audios in a timely fashion. If a government agency, for example, wants to make systematic and rapid changes to large numbers of audios instantly, it may not currently be possible with existing systems and methods. It also may not be possible to replace large numbers of audios on a scheduled or recurring basis. The operator would have to go to each record they want to change, record a new audio, and upload it individually, one at a time, for multiple locations. Typical audio tours have many hundreds of audio records and changing large numbers of them on a frequent basis would take an operator a large amount of time. This is why audios are not frequently changed.

The content management method and system disclosed herein have features that allow an operator to readily change messages for a location or group of locations. For a particular location, two or more messages may be stored, such as in a message database, one a “primary” message for the location, which is a primary message that is presented to users by default, and the other(s) a conditional message that is presented to users (either in place of the primary message or in addition to the primary message) when the conditions associated with activation of that conditional message are currently met. For audio messages, either or both of the primary message and conditional message(s) could be created by the operator recording the audio and/or by the operator entering text for each message and using a generative AI capability to automatically convert the text to an audio by an AI-cloned voice. For conditional messages, the operator also enters the conditions under which the conditional message is to be activated and deactivated (the deactivation condition may simply be that the condition for activation is not currently met). Once created, the message may be reviewed and, once approved, imported into the record and saved on a server (such as in a message database stored on such server). The messages can then be received from the server by the GPS audio tour app to be played at specific locations, with the message presented to users in that location being selected based on whether or not the conditions for the conditional message(s) are currently met. The messages may be stored on the server and accessed as appropriate and/or may be stored locally on an application run by a user device (which can allow conditional messages to be presented at the appropriate time without being dependent on the user device being able to access the server). Where messages are stored locally on a user device, the messages to be stored may be a subset defined by criteria such as geography, user stored itinerary, user interests, etc. For example, only messages associated with locations with the user's state/province/region could be stored, only messages for locations within a specified distance (as determined by geographical distance and/or travel time) of the user current location (to be periodically updated) could be stored, only messages for locations matching a stored user itinerary could be stored, etc. Similarly, messages to be stored could be filtered by user interests so that conditional messages relating to events unlikely to interest the user would not be stored locally.

As one example, the condition could be based on date, and the operator may be presented with a calendar-view option to schedule when a temporary conditional message for a location or group of locations should be presented to users in the location(s) by a GPS audio tour app. The operator may also be able to specify whether it is a recurring audio that should be activated on a repeating, scheduled timeframe. For example, the temporary message could be presented to the user every Friday or every weekend, and limited so that it only is available during the summer. The operator could specify how long the conditional audio message should be presented and when it should be replaced by just the primary audio message (in which case, the current date being between (inclusive) the start date and the last day preceding the stop date would be the condition for activation, and the current date being outside these dates would be the condition for deactivation). Such conditional messages can be stored locally on the user device and activated for presentation to the user at the appropriate time. Conditional audio messages could also be flagged in a category, so that all audios in that category could be activated or deactivated when that category is selected (such activation being by direct action of an operator or subject to one or more activation conditions for that category currently being met). Categorizing could be applied to conditional messages (such as all messages associated with a particular social event) and/or applied to types of locations (such as all locations subject to a particular type of inclement weather).

These features give tremendous power to the operator/administrator of the GPS audio tour and allows private companies, municipalities, and other sponsors of such tours to take advantage of this technology.

As an example of how the method and/or system could operate, consider a town where the local government agency responsible for tourism has created or wishes to create an audio tour to showcase locations in the town. In addition, the town hosts events, for example a regional Bluegrass Festival. This is an event that has been scheduled ahead of time and the town would like as many visitors as possible to attend it. Then, for the duration of the festival, one or more prescheduled, temporary (conditional) audio messages could be activated such that when a user enters a location within the town, the conditional message is presented via the user's mobile device (such as via an app running on the device) to provide the user, as they enter town, with information about the festival. Optionally, such messages could also be presented to users located outside the area if they select the particular location on an app, such as by clicking on a map point displayed on a user device. Such temporary message could be pulled from a centralized server at the time and/or could be stored locally on the user's device and only activated at the appropriate time. Once the festival date has passed, the conditional messages for all locations within the town could then be deactivated such that only the primary messages stored for locations within the town are presented to users when they enter those locations.

Another example might be a recurring social event such as Open Mic Night-Held the 3rd Sunday of every month at the Presbyterian Church Fellowship Hall. A conditional message could be set such that every 3rd Sunday, a temporary audio message that informs users about the event could be activated to be presented to users within an appropriate group of locations, and then deactivated each 3^{rd} Sunday when the event is over.

Other conditions than temporal conditions could be used, such as conditions that impact travel (inclement weather, traffic accidents, road construction, law enforcement operations, etc.) For example, locations ahead of a construction zone could have a conditional audio message ahead of such construction zone advising drivers with suggestions on how to avoid it, reducing congestion. A message such as, “Just a head's up. There will be some road construction in about 3 miles. Unless you need to be in that specific area, you might want to hang a right at 3rd street up ahead and then a left on Maple Street to avoid it. If you go that route, as you are driving I'll point out when you're past the area of construction so you can get back on this main road.” The location beyond the construction could then have another temporary audio message at the spot where they can rejoin the road. When the road construction is complete, those temporary audio messages could then be deactivated (in this case, activation and deactivation may be done by direct action of an operator, with the operator's control serving as the conditions for activation and deactivation).

In another case, there may be an emergency affecting a particular location. The operator could set an activation radius centered on that location (or a group of locations that are categorized as being within a relevant area) and set a temporary message to be presented to users within the activation radius, such as “Hey, I wanted to alert you to an issue. There's a broken water main downtown and the police are not letting anyone into the riverfront area until everything is cleaned up. If that's your destination, better think of another place to go.” Such message, provided in advance before users approach the area where emergency crews need to address the emergency, would deter users from entering the area and thus serve to reduce congestion for crews responding to the emergency. Again, in this case the conditions for activation and deactivation of the conditional message could simply be the operator directly instructing the message to be activated and deactivated. In such cases, activation and delivery of the conditional message may be controlled via a central server.

In an example of weather-related conditions for activation, conditional messages could be recorded as flagged audio messages for locations prone to ice under certain conditions of temperature, humidity, and/or precipitation. Examples of such locations could be one or more bridges that are notoriously icy, roadways near rivers, locations with poor drainage, etc. Each of these locations could be flagged with the Ice flag. Whenever weather conditions exist that warrant it, an operator could directly activate the Ice flag and all the audio messages that are safety-related regarding icy conditions would temporarily be activated so as to be presented by the end user app of any user within the activation radius for ice-flagged locations (and, optionally, for any users clicking on a map location that is ice-flagged). Thus, as a user approaches a bridge that is known to ice up, a flagged audio could say, “Now be real cautious and slow down before crossing that bridge up ahead. It ices up often in conditions like this so you want to be real careful when crossing it.” Multiple areas of the town that officials want to warn people about could also get these temporary audios when the “Ice” flag is pushed, using either conditional messages retrieved from a central server or by activating conditional messages stored on the user device in association with the end user app. When the weather warms up, the operator could simply disable the “Ice” flag and the primary audios for the flagged locations would again be presented to users. As an alternative (or supplement), the method and/or system could obtain information on current weather conditions from an appropriate source (such as a weather application, National Weather Service website, etc.) to automatically activate and deactivate such conditional messages when the current weather conditions indicate an icing risk. Conditional messages and/or locations could also have flagged audio messages for groups of temporary audio messages related to sporting events, concerts, and other singular events that might be helpful for giving guidance to visitors.

The method and/or system may allow for more than one conditional audio message to be associated with one or more locations, and messages could be scheduled to change over time. For instance, if the town has a live theatre group and the schedule of performances is known, an operator could set a series of related conditional messages such that the activated message changes weekly to describe what play is being performed that particular week. Such message for the week could be presented in combination with a message that does not change weekly, presenting information on the theatre group, which itself may have an activation period, such as only being active during the summer months.

The method and/or system may include conditional messages to be associated with locations not having an associated primary message. For example, conditional messages based on situations that may impact travel (such as inclement weather conditions, construction, etc.) may be provided for locations where such travel advisories would be helpful to users, but where the locations themselves would not otherwise merit a primary message. In the example of warning of bridges susceptible to ice, warning of icy conditions would be beneficial for all such bridges, regardless of whether any particular bridge is noteworthy enough to have a primary message associated with it (a bridge of historic and/or architectural interest may have an informational primary message, whereas a relatively modern bridge of thoroughly conventional construction may not).

Conditional messages could be “flagged” based on any criteria that the operator feels appropriate for a group of conditional messages to be activated under the same circumstances. An operator may have the option to generate any flag they want. They could create any flag with any word or short phrase and then flag any audio point with the flags they have already created. There could be an ice flag, but there could also be “The mayor's favorite summer spots” flag, or “Records from midnight to 2 am” flag, or even “Things I activate when I feel like it” flag. Any examples of flags described herein are merely representative of a common potential use case. Flagged audios can be simply a way to group and deploy, as a group, conditional audios that are needed at a specific time or under specific conditions. For example, a certain kind of weather might deploy a dozen conditional audios relevant to that weather. Or if there is a sporting event where authorities like to direct traffic in specific areas, messages flagged accordingly could all be activated for that event then deactivated when not needed. Depending on the particular method and/or system, flagged messages could be treated as a category of conditional message or could be handled independently of other categories (for example, in one scheme some category messages could be stored on a user device and activated under control of the device, while flagged messages could be stored on a central server and activated by deliberate action of the operator).

The ability to be able to readily make large numbers of temporary or otherwise conditional audio message files that are to be presented to app users at appropriate times and/or conditions brings great convenience to operators/administrators of such audio tours and becomes very attractive to local governments, tourism bureaus, and other officials who want to be able to provide information to their visitors, and change the message presented to users within a location or group of locations during various conditions and circumstances. Such apps may be set to silence whatever music or news the driver is listening to play on the speakers. When an audio message is activated, the app could stop the music or other audio program playing, deliver the conditional message, then turn the audio program back on. In some cases, whether or not to interrupt the current audio program could be a part of the activation criteria recorded for a particular message, where the operator may want to interrupt the audio program of the user with urgent messages (such as relating to emergency situations, inclement weather conditions, etc.) but not interrupt for less important messages (such as information on social events).

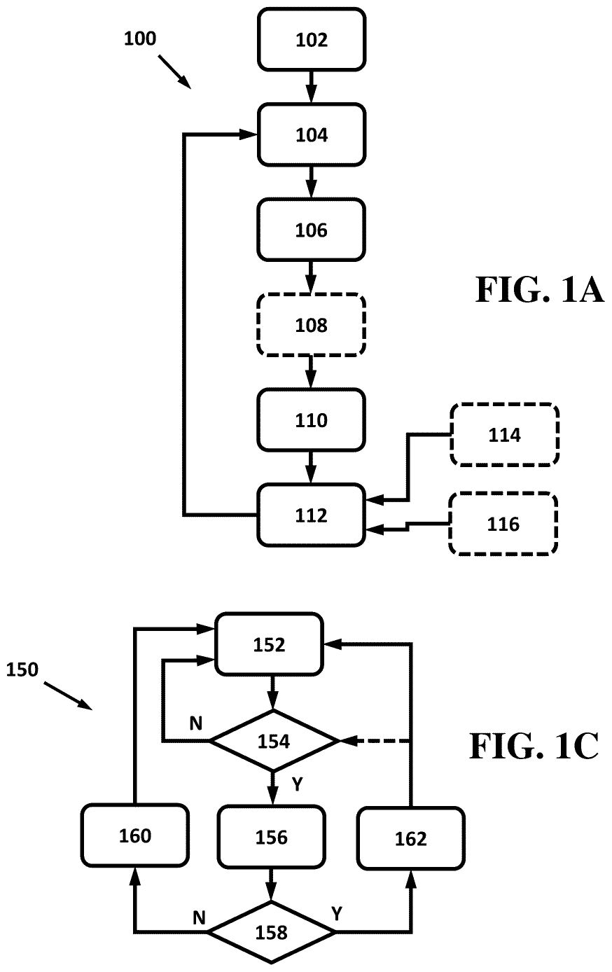

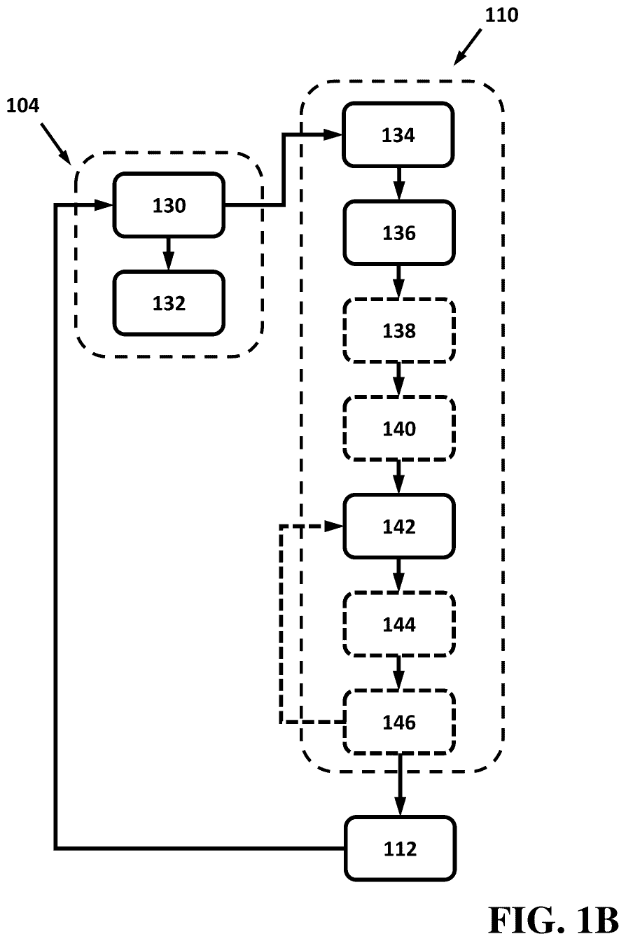

FIG. 1A-1C are flow charts illustrating one example of a method for creating conditional location-based messages and presenting such messages to users when appropriate. The method can be broadly broken into a method or routine 100 for an operator to create conditional message records for one or more locations and a method or routine 150 for presenting appropriate messages to a user.

Referring to FIG. 1A, the method 100 may start with the operator logging into a system (step 102); such step may include conventional security and/or account management features to limit access to authorized personnel. The login credentials of the operator entered in step 102 may define what area of locations the user is authorized to enter records for, when the method is employed by operators in multiple jurisdictions (such as one or more operators with authority to record and manage messages for a town or city, and another operator or group of operators with authority to record and manage messages within a park or museum that lies partially or fully within that town or city). For simplicity, the method and system are discussed with respect to a single jurisdiction and operator.

Once logged in, the operator can select a location (step 104) for which a record is to be created or edited. The method may present a map interface to the user to facilitate selecting a location, and may automatically fill in geographical identity information (such as geographical coordinates) for the location upon selection (such as by tapping a location presented on the map interface). The operator may then enter location data (step 106) such as a title for the location, activation radius for which conditional messages are to be provided (which could differ for different types or categories of conditional messages), type or category of location, travel direction (for waypoint locations where the message(s) for an end user may differ depending on the user's direction of travel), etc. The operator may optionally create a primary message for the location (step 108), which typically provides information on a location that is essentially constant and not subject to frequent change, such as historical information about the location. Data entry by the operator may be accomplished through a menu of prompts, such as by presenting the operator with one or more menus of options via an operator interface and allowing the operator to select from the options displayed.

The operator then creates a conditional message for the location (step 110). Such creation (discussed in greater detail with regard to FIG. 1B) may include entering message information for the location (or group of locations), which information typically includes the content of the message and the conditions under which it is to be activated, and optionally one or more message categories). Step 110 may include reviewing, editing, and approving the message. In some cases, the operator records an audio message. In some cases, the operator enters text that is converted to a synthesized audio message by a generative AI or similar capability.

Once a message has been created and, optionally, reviewed, edited, and approved by the operator in step 110, the operator publishes (step 112) the new/updated record for the conditional message. Such publication updates the record associated with the location to include the conditional message such that, when a user enters within the activation radius of the location and the specified condition(s) associated with the conditional message is in effect, the conditional message will be presented to the user.

The conditions under which one or more conditional messages are activated could be by direct action of the operator, either supplementing one or more other activation conditions or as the sole condition. In such cases, the method for any particular conditional message may include the operator directly causing activation of conditional message (step 114), in which case the publication step 112 includes activating the conditional message for any users in or entering the associated location(s). The operator can also directly cause the deactivation of the conditional message (step 116), in which case the publication step 112 sets the status of the conditional message as being inactive such that it is not presented to users in or entering the associated location(s).

FIG. 1B illustrates one example of steps of routines that could be employed to perform the steps shown in method 100 for choosing a location (step 104) and entering conditional message data for that location (step 110). In the example illustrated, the operator upon gaining access (such as by logging in in step 102) is presented with a map display (step 130). The choice of location may be defined by the account of the operator, such as presenting a municipal operator with a map view of the city for which they have authority to create location-based messages. The operator then selects (step 132) a location displayed on the map, such as by tapping on the location (perhaps after using options to scroll, magnify, etc. to more precisely define the location). The geographical identity of the location (such as geographical grid coordinates) may be automatically loaded into the record based on the operator's selection.

Once the geographical identity of the location has been provided (step 132), the operator may be prompted (step 134) to create or edit a conditional message record for that location. The operator enters data for the conditional message in step 136. (The operator may follow a similar process as described hereafter to enter or edit information for a primary message for the location, but without entering data on activation/deactivation conditions. As noted elsewhere, some locations may not have an associated primary message.) Such information typically includes the conditions under which the message should be activated and deactivated, and may include whether the conditional message should replace any primary message or supplement such primary message (which could further include whether to be presented before or after such message). It should be noted that the deactivation condition in many cases is simply the absence of the activation condition. For example, if the activation condition is a range of dates, the deactivation condition is once the range of activation dates has elapsed. In another example, if the activation condition is the presence of an alert on a particular weather condition, the deactivation condition may be when such condition no longer exists. The conditional message data may include the operator selecting a category (or multiple categories) for the conditional message (step 138). Such categories could include message type (for example, to activate all messages relating to a public social event during the time that such event is held) and/or location type (such as to activate all locations within a specified area, or all locations having similar characteristics such as similar susceptibility to a weather condition). In many cases, the conditions under which the message is to be activated and deactivated are based on date and/or time (for convenience, discussed hereafter simply as “date”). In such cases, the operator may select the activation and deactivation dates (step 140) by interacting with a calendar view.

Once the conditions and any other data relating to how the conditional message should be considered have been entered, the operator creates the conditional message itself (step 142). However, the order of these steps is somewhat arbitrary, and the user could create the message (step 142) first and then subsequently enter information (steps 136-140) on the activation conditions and category, if any. For the case of an audio message, the user may perform step 142 by recording themselves speaking a message, or by entering text and having a voice message synthetically generated, such as by use of a generative AI capability. The operator may optionally be presented with the message for review (step 144), in which case the operator may be prompted to either approve or disapprove the message (step 146). If disapproved, the operator may be further allowed the option to recreate and/or edit the message, or to cancel the process (indicated by dashed line back to step 142, although the process could return to a different point). Once approved, the conditional message is published for presentation to users when appropriate (such as via publication step 112 shown in FIG. 1A).

FIG. 1C illustrates steps of a routine 150 for determining what location-based messages to provide to a user. To start, the current location of the user is determined in step 152. Such current location may be determined by a navigation application operating on a mobile device carried by the user that determines the location of such device via GPS signals, analysis of cellular transmitting towers, and/or other conventional techniques. Such location determination could be performed by an existing navigation/locating application and/or by a dedicated process. The current location of the user can then be compared to the activation radii for any locations associated with recorded messages to determine whether user is within activation radius of a message location (step 154). If not, the current location continues to be monitored and compared to message locations. In the event that the user is determined in step 154 to be within the activation radius of a message location, the record of messages for location is accessed (step 156) and for any conditional messages, a determination is made (step 158) of whether the condition for presenting such message is currently in effect. If not, then any primary message that has been recorded for that location is presented to the user (step 160); if no primary message has been recorded for the location, then no message is presented. If the condition(s) for presentation of a conditional message for the location is currently in effect, then the user is presented with the conditional message (step 162). Such presentation may replace a primary message (if any) for that location, or may present the conditional message in combination with the primary message (in which case, presenting the combined message can be considered as presenting the conditional message). The steps of the routine then repeat, such as by return to step 152 of determining the user location. In some cases, the routine could repeatedly monitor as to whether the condition for activation remains in effect without checking for location (as indicated by the dashed line from step 162 to step 154) and, when no longer in effect (which can be treated as the same as a deactivation condition being in effect), the user is presented with the primary message (if any for that location).

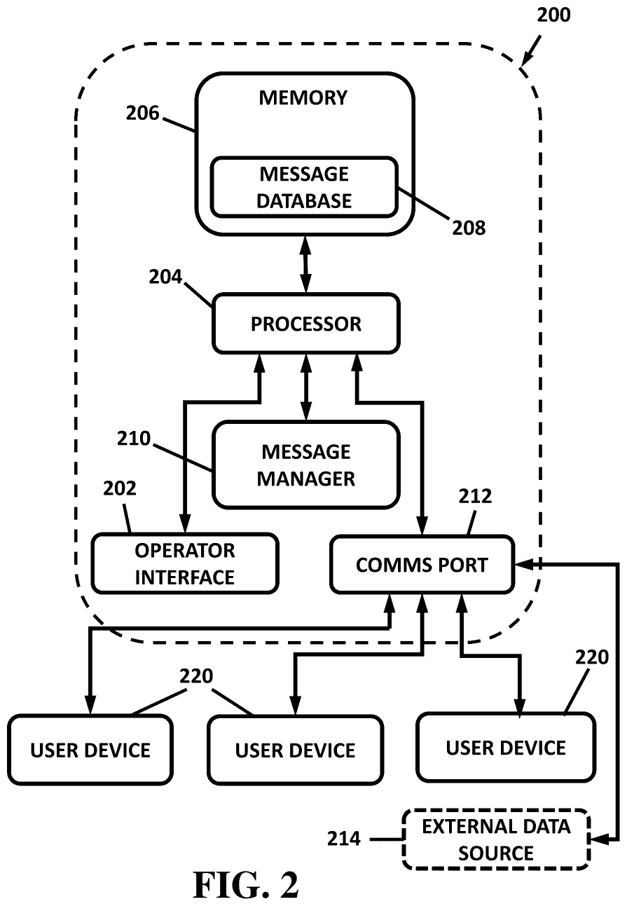

FIG. 2 is a block diagram showing one example of a system 200 that could be employed to perform methods such as discussed above. The system 200 includes an operator interface 202 that allows an operator to interact with a processor 204. The operator interface 202 and processor 204 can be provided by any conventional computing device, such as a desktop or laptop computer, smart phone, tablet, or other computing device. In many cases, the components of the system operate via instructions operating on a conventional computing device, and the operator interface allows the operator to enter date and commands to the processor 204, as well as displaying information from the processor 204 to the operator. The processor 204 can access a memory 206 that includes a message database 208 that stores primary and conditional messages for a number of associated locations. A message manager 210 interacts with the processor 204 to allow the user to create message records for storage in the message database 208 and to determine when it is appropriate for a message to be presented to an end user.

A communications port 212 allows communications between the processor 204 and a number of end user devices 220. The user devices 220 are mobile devices such as smart phones and/or vehicle navigation systems that provide information for users, and typically include several features not illustrated (user interface, processor, memory, communications capability, location capability, etc.) It should be noted that some functions performed by components illustrated as part of the system 200 may be performed partially or entirely by software instructions running on the user devices 220 or other external capability. For example, the message database 208 could be stored on a number of servers that are accessed directly by the user devices 220, and the functions of the message manager 210 that relate to determining when a message should be presented could be performed by an application operating on the user device 220, responsive to a location/navigation application (an existing application and/or a dedicated application) that provides information on the location of the user, an internal calendar/clock of the user device 220 that provides information on the current date and/or time, a weather-monitoring and/or traffic advisory application operating on the user device that provides information relevant to travel conditions, etc. Alternatively, some or all of the message database 208 could be stored locally on the user devices 220 to allow the system to function without relying on communication between the user devices 220 and the communications port 212. The communications port 212 may also communicate with an external data source 214 that can provide the processor 204 (and thus the message manager 210 as well) with access to external information sources such as an external geographical information source (which can generate maps and identify the coordinates of selected locations), an external account/access management system (to limit access to authorized personnel), an external weather and/or traffic information source, an external community calendar (for providing public social event information), an external voice synthesis application (for converting text messages to audio), and/or any other external information source that may be helpful in performing the functions of the system 200.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that a certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for managing location-based content, comprising the steps of:
creating a record for at least one location, such record for each location including a geographical identity of the location, an activation radius, and a conditional message for the location, defining at least one condition under which the conditional message is to be activated and at least one condition under which the conditional message is to be deactivated;
determining whether the at least one condition under which the conditional message is to be activated is currently met and, responsive to such determination, activating the conditional message to be presented to users located within the activation radius; and
determining whether the at least one condition under which the conditional message is to be deactivated is currently met and, responsive to such determination, deactivating the conditional message.

2. The method of claim 1 wherein said step of creating a record further comprises creating a primary message for each of at least a subset of locations, and creating a record of whether a particular conditional message for that location should replace the primary message,
wherein said step of activating the conditional message includes checking the record for the conditional message to be activated to determine whether the conditional message should replace the primary message and,
if so, replacing the primary message with the conditional message until such time as a determination is made to deactivate the conditional message, at which time the primary message replaces the conditional message,
alternatively, presenting users with both the conditional message and the primary message until such time as a determination is made to deactivate the conditional message, at which time the conditional message is deactivated and only the primary message is presented to users within the activation radius.

3. The method of claim 1 wherein said step of creating a record further comprises, for at least a subset of conditional messages, recording a category for each such conditional message, such categorized conditional message being common to at least a subset of locations, further wherein said step of activating the conditional message comprises activating the conditional message for users located within the activation radius of all locations to which the category of the activated message is common.

4. The method of claim 1 wherein the conditions under which a conditional message is activated and deactivated include at least one condition selected from the group of:
an activation time/date and a deactivation time/date;
the onset and cease of a defined weather condition;
the onset and cease of an activity that impacts road travel; and
the onset and cease of a community social activity.

5. The method of claim 1 wherein the conditions under which a conditional message is activated and deactivated include direct activation and deactivation by an operator.

6. The method of claim 1 wherein the conditional messages are audio messages and are created by at least one technique selected from the group of:
recording audio of an operator delivering the message; and
using a computer-generation capability to convert text entered by an operator into computer-generated audio.

7. The method of claim 1 further comprising the step of:
communicating the conditional message to at least one user device,
wherein said steps of determining whether the conditional message is to be activated and activating the conditional message and determining whether the conditional message is to be deactivated and deactivating the conditional message are performed, at least in part, by the user device.

8. A storage medium comprising instructions that, when executed by a processing device, executes the method of claim 1.

9. A system for managing location-based content, the system comprising:
a message database;
at least one operator interface programmed to allow an operator to create a record in said message database for at least one location, such record for each location including geographical coordinates of the location, an activation radius, and a conditional message for the location,
said operator interface also being programmed to allow an operator to define at least one condition under which the conditional message is to be activated and at least one condition under which the conditional message is to be deactivated;
at least one communication channel for communicating conditional messages to at least user devices located within the activation radius of any location associated with that conditional message;
a message manager programmed to determine whether the at least one condition under which the conditional message is to be activated is currently met and, responsive to such determination, presenting the conditional message via user devices located within the activation radius, and
said message manager also being programmed to determine whether the at least one condition under which the conditional message is to be deactivated is currently met and, responsive to such determination, deactivating the conditional message.

10. The system of claim 9 wherein said operator interface is further programmed to allow an operator to create a primary message in said message database for each of at least a subset of locations, and to record in said message database whether a particular conditional message for that location should replace the primary message when activated,
wherein said message manager is programmed to, upon determining that a conditional message is to be activated, check the record for the conditional message to determine whether the conditional message should replace the primary message and,
if so, said message manager replacing the primary message with the conditional message until such time as a determination is made to deactivate the conditional message, at which time the primary message replaces the conditional message,
alternatively, said message manager presenting both the conditional message and the primary message via user devices within the activation radius until such time as a determination is made to deactivate the conditional message, at which time the conditional message is deactivated and only the primary message is presented via user devices.

11. The system of claim 9 wherein said operator interface is programmed to allow an operator to record in said message database, for at least a subset of conditional messages, a category for each such conditional message, such categorized conditional message being common to at least a subset of locations,
further wherein said message manager is programmed such that, when it is determined that a categorized message is to be activated, said message manager presents such conditional message via user devices located within the activation radius of all locations to which the category of the activated conditional message is common.

12. The system of claim 9 wherein the conditions under which a conditional message is activated and deactivated include at least one condition selected from the group of:
an activation time/date and a deactivation time/date;
the onset and cease of a defined weather condition;
the onset and cease of an activity that impacts road travel; and
the onset and cease of a community social activity.

13. The system of claim 9 wherein said message manager is programmed to allow an operator to directly activate and deactivate a conditional message.

14. The system of claim 9 wherein said message database stores the conditional messages as audio messages and said operator interface is programmed to allow an operator to create such audio messages by at least one technique selected from the group of:
recording audio of an operator delivering the message; and
using a computer-generation capability to convert text entered by an operator into computer-generated audio.

15. The system of claim 9 wherein said message database and said message manager are provided, at least in part, by at least one application operating on a user device.
